(19) United States
(12) Patent Application Publication
(10) Pub. No.: US 2015/0286345 A1
(43) Pub. Date: Oct. 8, 2015

(54) SYSTEMS, METHODS, AND COMPUTER-READABLE MEDIA FOR INPUT-PROXIMATE AND CONTEXT-BASED MENUS

(71) Applicant: Bellefield, LLC, Pittsburgh, PA (US)

(72) Inventor: Daniel Garcia-Sanchez, Wexford, PA (US)

(21) Appl. No.: 14/243,548

(22) Filed: Apr. 2, 2014

(51) Int. Cl. G06F 3/0482; G06F 3/0488; G06F 3/0481; G06F 3/0484

(52) U.S. Cl. CPC G06F 3/0482; G06F 3/04842; G06F 3/04883; G06F 3/04817

(57) ABSTRACT

Systems, methods and computer-readable storage media for presenting an input-proximate and context-based menu interface are disclosed. A menu interface system may be configured to receive one or more user inputs, such as touch gestures received through a touch screen interface. The menu interface system may analyze the one or more user inputs and any objects activated by a user input to determine available menu functions, such as edit, delete, highlight, annotate, execute, or the like. A menu interface may be presented to the user displaying the menu functions. A user may select a menu function to evoke the associated function, such as highlighting selected text.

### BACKGROUND

Technological advances in mobile computing devices, particularly tablet computing devices operating through touch screen input, have given users the ability to perform many fundamental tasks using more natural input gestures that improve efficiency and the overall user experience. Nonetheless, certain basic functions remain tedious and prone to user error, particularly when repeated numerous times.

Illustrative basic functions that remain a challenge are data entry and the modification and/or annotation of electronic documents, such as a scanned document file, word processing document, or data entry records in a data entry field, such as a spreadsheet or database table. In general, software applications provide for the modification and/or annotation of electronic documents using a pre-packaged set of commands on a menu or toolbar. Such menus are typically positioned at the top or side of the display area for the electronic document. The annotation of a series of records or a section of text necessitates the continuous shift of focus back and forth between the data entry field or section of text and the menu in order to activate the annotation, such as a text highlight or font color function, annotate the data entry record or section of text, and deactivate the annotation function. In addition, such shift of focus must be repeated for each annotation and/or each time a different annotation function is required. Thus, despite advances in software and mobile computing device technology, data entry and document annotation remain a constrained, low-productivity process. Accordingly, it would be beneficial to provide solutions capable of efficiently and effectively addressing the multiple factors that prevent data entry and document annotation within a productive, positive user experience.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system for presenting a context-based menu in proximity to user input may include a processor and a non-transitory, computer-readable storage medium in operable communication with the processor. The computer-readable storage medium may contain one or more programming instructions that, when executed, cause the processor to receive input information associated with a first user input from the at least one input device, the input information comprising at least one input characteristic and a position, determine at least one active object selected by the first user input, determine at least one menu function based on at least one of the at least one input characteristic and the at least one active object, generate at least one menu interface configured to be presented on the display proximate to the position and having the at least one menu function displayed thereon, receive input information associated with a second user input from the at least one input device indicating a selection of the at least one function on the menu interface, and activate the at least one selected function.

In an embodiment, a computer-implemented method for presenting a context-based menu in proximity to user input may include, by a processor, receiving input information associated with a first user input from at least one input device operably coupled to the processor, the input information comprising at least one input characteristic and a position, determining at least one active object selected by the first user input, determining at least one menu function based on at least one of the at least one input characteristic and the at least one active object, generating at least one menu interface configured to be presented on a display operably coupled to the processor, the at least one menu interface being presented proximate to the position and having the at least one menu function displayed thereon, receiving input information associated with a second user input from the at least one input device indicating a selection of the at least one function on the menu interface, and activating the at least one selected function.

In an embodiment, a computer-readable storage medium having computer-readable program code configured to presenting a context-based menu in proximity to user input embodied therewith. The computer-readable program code may include computer-readable program code configured to receive input information associated with a first user input from the at least one input device, the input information comprising at least one input characteristic and a position, computer-readable program code configured to determine at least one active object selected by the first user input, computer-readable program code configured to determine at least one menu function based on at least one of the at least one input characteristic and the at least one active object, computer-readable program code configured to generate at least one menu interface configured to be presented on the display proximate to the position and having the at least one menu function displayed thereon, computer-readable program code configured to receive input information associated with a second user input from the at least one input device indicating a selection of the at least one function on the menu interface, and computer-readable program code configured to activate the at least one selected function.

### BRIEF DESCRIPTION OF THE DRAWINGS

The above and other objects of the present invention will become more readily apparent from the following detailed description taken in connection with the accompanying drawings.

FIG. 1 depicts an input-proximate and context-based menu interface system according to some embodiments

FIG. 2 depicts an illustrative menu interface system according to a first embodiment.

FIG. 3 depicts an illustrative menu interface system according to a second embodiment.

FIG. 4 depicts a flow diagram for an illustrative method for presenting a menu interface using a menu interface system configured according to some embodiments.

FIG. 5 illustrates a block diagram of an illustrative embodiment of a computing device for implementing the various methods and processes described herein.

### DETAILED DESCRIPTION

The described technology generally relates to systems, methods, and computer-readable media for providing input-proximate and/or context-based menu interfaces (the “menu interfaces”) within a computing environment. In some embodiments, the computing environment may be configured to receive touch input gestures, for example, using a touchscreen device. In some embodiments, the computing environment may be presented through a mobile computing device, such as a mobile phone (for instance, a smartphone) or a tablet computing device.

The menu interfaces may be presented based on various characteristics of input received at a computing device, such as the location of the input on an interface, the object(s) selected by the input, and the nature of the input gesture (for example, a single-touch or click, a double-touch or click, a circle motion, a select-and-hold, a swipe, or the like). For example, the menu interfaces may be presented proximate or immediately adjacent to an input gesture (“input-proximate”). In this manner, a user is not required to shift focus from the input gesture area to search for a menu item. In another example, one or more functions may be presented on the menu interfaces based on the characteristics of the input gesture (“context-based”). For instance, a set of functions for modifying, annotating, or otherwise working with a particular object may be presented on a menu interface responsive to selection of the object and/or based on the interaction between the input gesture and the object, such as circling the object, single-touching of or single-clicking on the object, select-and-hold input on the object, swiping on or near the object, or the like. As such, a user may be presented with menu interfaces based on the particular object as well as the type of interaction with the object.

In some embodiments, the menu interfaces may be configured to provide a set of tools for the efficient performance of tasks that are customarily performed through traditional “pen and paper” methods but which have been converted to a computer-implemented process. For instance, each type of business typically has certain tasks that have traditionally been performed using physical documents. Certain examples include the review, modification, and annotation of client invoices (for instance, pro formas or pre-bills at law firms), vendor invoices, shipping invoices, purchase orders, insurance applications, medical information forms, or the like. These tasks have resisted conversion to electronic formats because it is perceived as being easier and less tedious to complete using physical documents than with electronic files. However, businesses and firms prefer to move such tasks to an electronic format to experience the benefits of more stable and secure documents that may be accessed from a computing network. Users would also prefer to move such tasks to an electronic format so that they may experience more flexibility in their ability to perform work, such as reviewing and annotating client invoices remotely using a tablet computing device and accessing or sending emails through a network or email. Accordingly, some embodiments present menu interfaces configured to provide users with a more efficient and natural user experience for performing various tasks within a computing environment that have traditionally been performed through “pen and paper” methods.

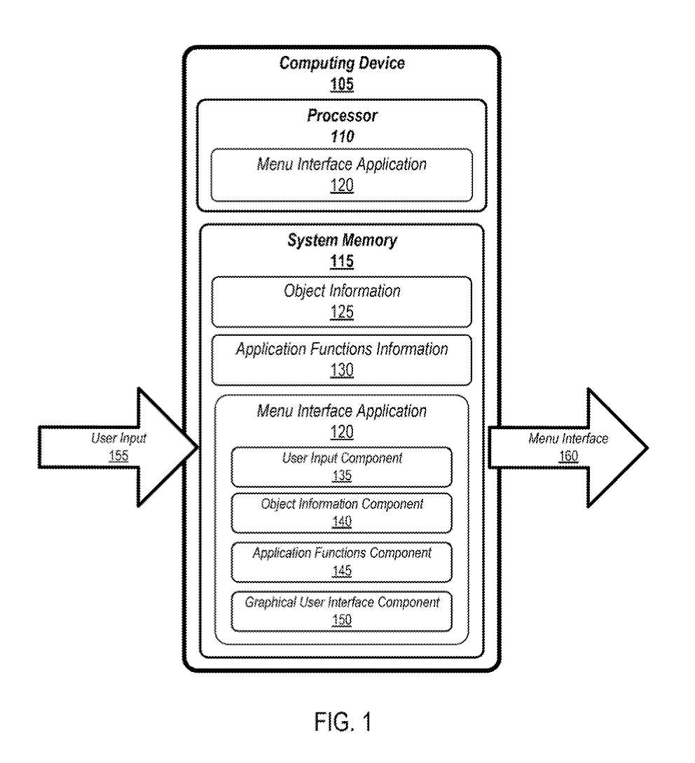

FIG. 1 depicts an input-proximate and context-based menu interface system (“menu interface system”) according to some embodiments. As shown in FIG. 1, a menu interface system may be implemented through a computing device 105 having a processor 110 and system memory 115. The computing device 105 may include one or more server computing devices, personal computers (PCs), kiosk computing devices, mobile computing devices, laptop computers, mobile phone devices, such as smartphones, tablet computing devices, automotive computing devices, personal digital assistants (PDAs), or any other logic and/or computing devices now known or developed in the future.

The processor 110 may be configured to execute a menu interface application 120. The menu interface application 120 may include various modules, programs, applications, routines, functions, processes, or the like (“components”) to perform functions according to some embodiments described herein. In some embodiments, the menu interface application 120 may include a user input component 135, an object information component 140, an application functions component 145, and/or a graphical user interface component 150.

The menu interface application 120 may be configured to receive user input 155, for instance, through an input device operably coupled to the computing device 105. Non-limiting examples of input devices may include touch screens, mouse input devices, track pads, touch pads, track balls, keyboards, pointing devices, combinations thereof, and/or any other type of device capable of communicating user input to the electronic device 105. In some embodiments in which the input device is a touch screen or other touch-based input device, the user input 155 may be in the form of touch gestures.

The user input component 135 may be configured to analyze user input 155 received by the menu interface application 120. The user input component 135 may analyze the user input 155 to determine various input characteristics associated with the user input. In some embodiments, the input characteristics may include the location of the user input 155, such as the location of the user input on a screen (for example, X-Y coordinates of the user input). In some embodiments, the input characteristics may include the gesture type of the user input 155, such as a single-touch or click, a double-touch or click, a select-and-hold, a circle (for instance, draw a circle around an object), a swipe, or any other type of gesture capable of being detected by the menu interface application 120. Non-limiting examples of other input characteristics may include duration, size, movement, active applications, active functions, previous user input 155 (for example, the immediately preceding user input), input context, and/or any other input characteristic capable of being detected by the menu interface application 120.

The object information component 140 may be configured to detect the object or objects and/or receive information associated with the object or objects that are the focus of the user input 155 (the “active object”). The object information component 140 may access object information 125, for example, stored in system memory 115 or on a network, including the Internet, associated with the active object. The object information 125 may include any information relating to the active object, including, without limitation, an object name, one or more associated applications and/or events (for instance, applications and events that are launched responsive to selection of the active object), an object type (for instance, text, numerical, graphical, or the like), one or more associated functions (for instance, modify text or numerical object, highlight, change color, annotate, associate with another object, or the like), one or more associated objects, or any other type of information that may be associated with an object.

The application functions component 145 may be configured to determine the menu functions available within an application and/or computing environment, including the functions that may be available for a particular active object. For example, the application functions component 145 may access application functions information 130 responsive to the menu interface application receiving user input 155 selecting an object. The application functions component 145 may be configured to determine which menu functions may be available for the object based on the application functions information 130 and/or the context of the user input (for example, as part of the input characteristics). In some embodiments, the application functions component 145 may determine the available functions for an active object and may add or remove functions from the set of available functions based on the context of the user input 155 to determine the menu functions that may be presented with the menu interface 160. The menu functions may include any menu function available for an object and/or application, including, for example and without limitation, an annotate function, an edit function, an application launch function, a delete function, a highlight function, a copy function, a cut function, a paste function, or the like.

For example, a first function and a second function may be available responsive to selection of an object within an data entry application in a particular context, such as an edit function and a highlight function for a data entry record object in a normal operating mode or context. However, the application functions component 145 may determine that the edit function is not available in a secure operating mode or context. In another example, a first set of menu functions may be available to a first user based on various characteristics of the first user, such as user preferences, security settings, or the like, while a second set of menu functions may be available to a second user based on various characteristics of the second user.

According to some embodiments, the context of user input 155 may include any information, environment, operating mode, object state, or the like that may affect the available menu functions for an active object. Non-limiting examples of context may include, an active user profile, user preferences, an active application, an application state, an object state, a number of active objects, other active objects, a computing device operating state, one or more security designations, one or more available functions, one or more unavailable functions, a previous context, one or more previously selected objects, one or more previous functions, a previous user input, or the like.

In some embodiments, the application functions component 145 may be configured to invoke a function based on, for instance, the user input 155 and the context. For example, if the user input 155 includes a select-and-hold input on a text object, the application functions component 145 may be configured to invoke a particular function on the text object, such as to highlight or change the color of the text object. In another example, if the user input 155 includes circling a graphical object (for instance, a digital image object), the application functions component 145 may be configured to cause the graphical object to be opened in an editor.

The graphical user interface (GUI) component 150 may be configured to provide the graphical representation of a menu interface 160 to the user, including the menu functions. The GUI component 150 may provide a menu interface 160 with available menu functions for the active object as determined by the application functions component 145. In some embodiments, the GUI component 150 may be configured to present the menu interface 160 in proximity to or immediately adjacent to the location of the user input 155. In some embodiments, the GUI component 150 may be configured to present the menu interface 160 in a location within a predetermined distance from the user input 155 and/or the active object. In some embodiments, the GUI component 150 may be configured to present the menu interface 160 as close as possible to the user input 155 and/or the active object. In some embodiments, the GUI component 150 may be configured to present the menu interface 160 based on the context of the user input 155. For example, the GUI component 150 may present the menu interface 160 such that it does not block certain objects, for example, information or objects that are likely to be needed by the user to perform one or more of the menu functions. In some embodiments, the GUI component 150 may rank or otherwise weight the objects visible on a user interface based on, for example, their relevance to the user input 155, and may present the menu interface 160 based on proximity to the user input and blocking lower-ranked objects.

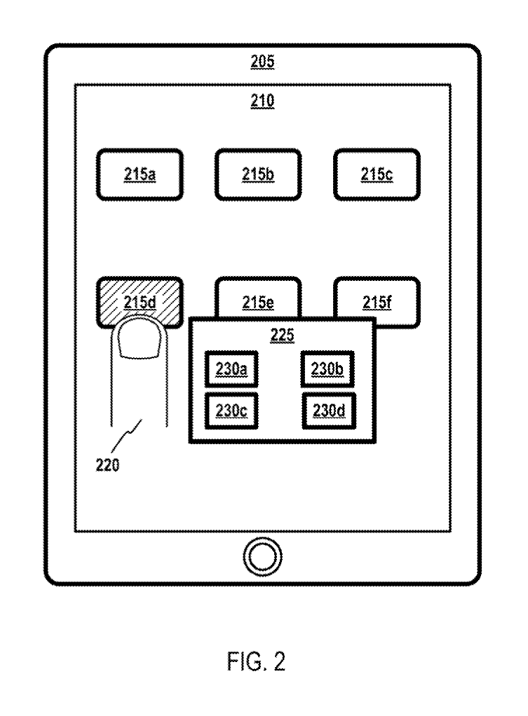

FIG. 2 depicts an illustrative menu interface system according to a first embodiment. As shown in FIG. 2, a computing device 205 may present a user interface 210 through a display. Objects 215a-f may be presented on the user interface 210. The objects 215a-f may include any type of object capable of being graphically represented and/or accessed through the user interface 210, including, without limitation, text, files, network locations, data records, application objects (for example, text boxes, spreadsheet cells, word processing objects, or the like), metadata, menus, toolbars, hyperlinks, applications, icons, or the like. User input 220, for instance, in the form of a touch gesture may be received by the user interface 210 (a “first touch gesture”). The user input 220 may be processed by the computing device 205 operating system and may be received by the menu interface application 120. The menu interface application 120 may analyze the input characteristics of the user input 220 and the active object 215d to determine the menu functions 230a-d associated with the user input. A menu interface 225 may be presented in proximity to the user input 220 that is configured to display the menu functions 230a-d. The user may select one of the menu functions 230a-d (a “second touch gesture”) to evoke the associated function. For example, the first touch gesture may select a text object on a portable document file (PDF), and the menu interface application 120 may present a menu interface 225 having menu functions 230a-d to edit the text. The second touch gesture may include selecting a menu function 230a to change the text to a “strikethrough” font.

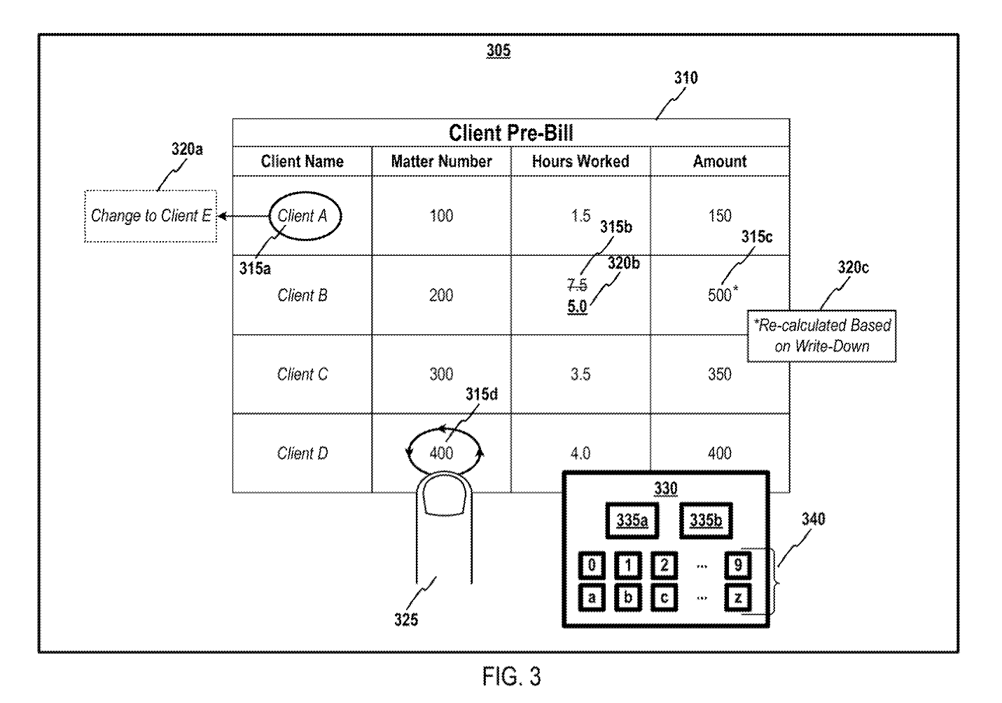

FIG. 3 depicts an illustrative menu interface system according to a second embodiment. As shown in FIG. 3, a user interface 305 may present an electronic document 310 (a law firm client pre-bill document), including, without limitation, a PDF file, data entry spreadsheet or database table, text document, rich text file, slide presentation, website, word processing document, or the like. Various objects 315a-d may be accessible on the electronic document 310. Although there are multiple objects depicted in FIG. 3, only objects 315a-d are labeled to reduce the complexity of the drawing. The electronic document 310 may be accessible through an application configured to allow modifications, annotations, and other changes to the electronic document.

As depicted in FIG. 3, a user may select one or more objects 315a-d through various types of input gestures 325, for example, by performing a circle input gesture (for example, circling the client name object 315a with their finger on a touch screen) to invoke a menu interface 330 displaying menu functions 335a, 335b and/or other features, such as alphanumeric buttons 340, a text box, a file dialog box, or the like. For example, a user may select the client name object 315a and may then select a menu function 335a, 335b to annotate the document, such as including a circle around the client name object 315a to indicate an annotation and an arrow pointing to the annotation object 320a. In another example, a user may select an hours worked object 315a, and a menu interface 330 may be presented by the menu interface application 120 allowing the user to edit 320b the hours worked object, for instance, by crossing out the text of the hours worked object and entering a new value. In a further example, the user may select an amount object 315c and may annotate 320c the amount object to indicate that the value has been changed based on the change to the corresponding hours worked object 315b.

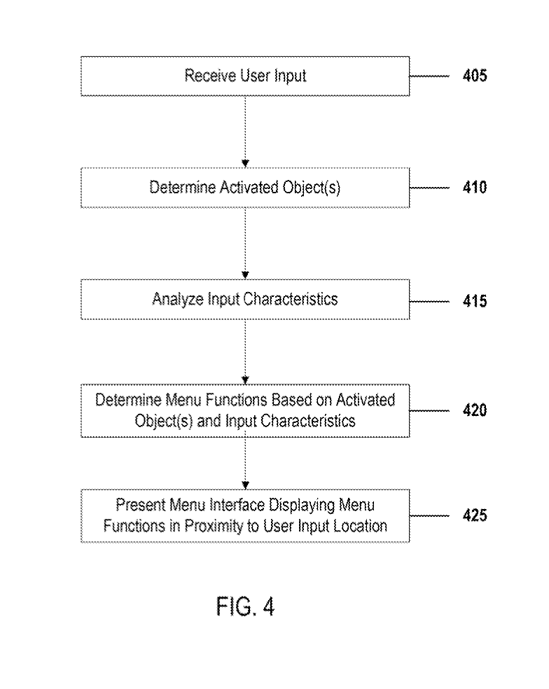

FIG. 4 depicts a flow diagram for an illustrative method for presenting a menu interface using a menu interface system configured according to some embodiments. User input may be received 405, for example, by a menu interface application 120 being executed on a processor 110 of a computing device 105. The object selected or activated by the user input may be determined 410, for example, by a user input component 135 of the menu interface application 120. The input characteristics of the user input may be analyzed 415, for instance, by the user input component 135 of the menu interface application 120. A set of applicable menu functions may be determined 420 based on the activated object and the input characteristics. The menu functions may be determined 420, for example, by the application functions component 145 of the menu interface application 120. A menu interface may be presented 425 by displaying the menu functions in proximity to the location of the user input, for instance, by the GUI interface component 150 of the menu interface application 120.

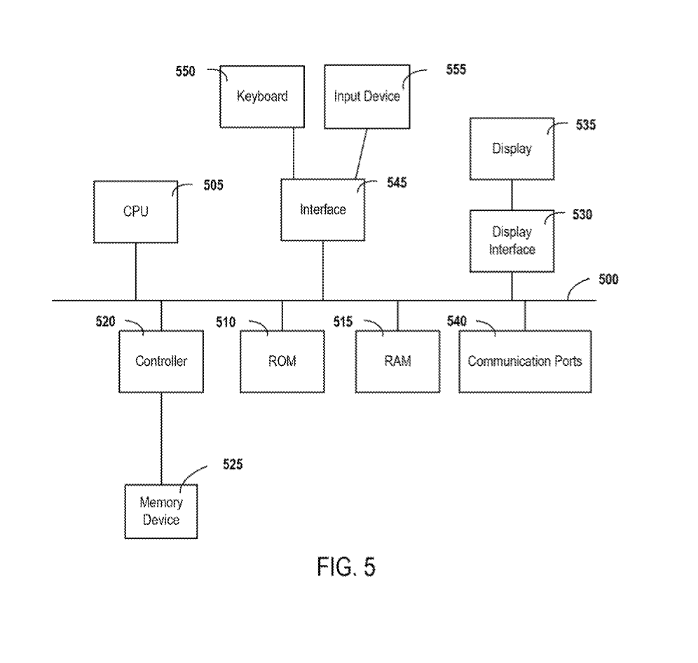

FIG. 5 depicts a block diagram of exemplary internal hardware that may be used to contain or implement the various computer processes and systems as discussed above. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an exemplary processing device, computing device or processor as such terms are used within this disclosure. Read only memory (ROM) 530 and random access memory (RAM) 535 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the functional steps associated with managing and incentivizing data entry as described above may be stored in the ROM 530 and/or the RAM 535. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 530 may permit information from the bus 500 to be displayed on the display 535 in audio, visual, graphic or alphanumeric format. Communication with external devices may occur using various communication ports 540. An exemplary communication port 540 may be attached to a communications network, such as the Internet or a local area network.

The hardware may also include an interface 545 which allows for receipt of data from input devices such as a keyboard 550 or other input device 555 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

What is claimed is:

1. A system for presenting a context-based menu in proximity to user input, the system comprising:
at least one input device;
a display
a processor in operable communication with the at least one input device and the display; and
a non-transitory, computer-readable storage medium in operable communication with the processor, wherein the computer-readable storage medium contains one or more programming instructions that, when executed, cause the processor to:
receive input information associated with a first user input from the at least one input device, the input information comprising at least one input characteristic and a position;
determine at least one active object selected by the first user input;
determine at least one menu function based on at least one of the at least one input characteristic and the at least one active object;
generate at least one menu interface configured to be presented on the display proximate to the position and having the at least one menu function displayed thereon;
receive input information associated with a second user input from the at least one input device indicating a selection of the at least one function on the menu interface; and
activate the at least one selected function.

2. The system of claim 1, wherein the at least one input device comprises a touch screen.

3. The system of claim 2, wherein each of the first user input and the second user input comprise a touch input gesture.

3. The system of claim 1, wherein the at least one active object comprises at least one of text, a file, a network location, a data record, an application object, a menu, a toolbar, a hyperlink, an application, and an icon.

4. The system of claim 1, wherein the first user input comprises at least one of a single-touch or click input gesture, a double-touch or click input gesture, a circle, a swipe, and a select-and-hold input gesture.

5. The system of claim 1, wherein the at least one menu function comprises at least one of an annotate function, an edit function, an application launch function, a delete function, and a highlight function.

6. The system of claim 1, wherein the computer-readable storage medium further contains one or more programming instructions that, when executed, cause the processor to:
assign weights to each of a plurality of visible objects; and
generate the menu interface such that the menu interface is presented on the display blocking at least one of the plurality visible objects based on the weights.

7. The system of claim 1, wherein the at least one input characteristic comprises at least one of an active user profile, a user preferences, an active application, an application state, an object state, a number of active objects, other active objects, a computing device operating state, a security designation, an available function, an unavailable functions, a previous context, a previously selected object, a previous function, and a previous user input.

8. A computer-implemented method for presenting a context-based menu in proximity to user input, the method comprising, by a processor:
receiving input information associated with a first user input from at least one input device operably coupled to the processor, the input information comprising at least one input characteristic and a position;
determining at least one active object selected by the first user input;
determining at least one menu function based on at least one of the at least one input characteristic and the at least one active object;
generating at least one menu interface configured to be presented on a display operably coupled to the processor, the at least one menu interface being presented proximate to the position and having the at least one menu function displayed thereon;
receiving input information associated with a second user input from the at least one input device indicating a selection of the at least one function on the menu interface; and
activating the at least one selected function.

9. The method of claim 8, wherein the first user input and the second user input comprise a touch input gesture.

10. The method of claim 8, wherein the at least one active object comprises at least one of text, a file, a network location, a data record, an application object, a menu, a toolbar, a hyperlink, an application, and an icon.

11. The method of claim 8, wherein the first input gesture comprises at least one of a single-touch or click input gesture, a double-touch or click input gesture, a circle gesture input gesture, and a select-and-hold input gesture.

12. The method of claim 8, wherein the at least one menu function comprises at least one of an annotate function, an edit function, an application launch function, a delete function, and a highlight function.

13. The method of claim 8, wherein the computer-readable storage medium further contains one or more programming instructions that, when executed, cause the processor to:
assign weights to each of a plurality of visible objects; and
generate the menu interface such that the menu interface is presented on the display blocking at least one of the plurality visible objects based on the weights.

14. The method of claim 8, wherein the at least one input characteristic comprises at least one of an active user profile, a user preference, an active application, an application state, an object state, a number of active objects, other active objects, a computing device operating state, a security designation, an available function, an unavailable function, a previous context, a previously selected object, a previous function, and a previous user input.

15. A computer-readable storage medium having computer-readable program code configured to presenting a context-based menu in proximity to user input embodied therewith, the computer-readable program code comprising:
computer-readable program code configured to receive input information associated with a first user input from the at least one input device, the input information comprising at least one input characteristic and a position;
computer-readable program code configured to determine at least one active object selected by the first user input;
computer-readable program code configured to determine at least one menu function based on at least one of the at least one input characteristic and the at least one active object;
computer-readable program code configured to generate at least one menu interface configured to be presented on the display proximate to the position and having the at least one menu function displayed thereon;
computer-readable program code configured to receive input information associated with a second user input from the at least one input device indicating a selection of the at least one function on the menu interface; and
computer-readable program code configured to activate the at least one selected function.

16. The computer-readable storage medium of claim 15, further comprising computer readable program code configured to receive the first user input and the second user input as a touch input gesture.

17. The computer-readable storage medium of claim 15, further comprising computer readable program code configured to assign weights to assign weights to each of a plurality of visible objects and generate the menu interface such that the menu interface is presented on the display blocking at least one of the plurality visible objects based on the weights.
